(19) United States
(12) Patent Application Publication
(10) Pub. No.: US 2013/0259794 A1
(43) Pub. Date: Oct. 3, 2013

(54) CARBON AND FUEL PRODUCTION FROM ATMOSPHERIC CO2 AND H2O BY ARTIFICIAL PHOTOSYNTHESIS AND METHOD OF OPERATION THEREOF

(71) Applicant: Edgar D. Young, Cashiers, NC (US)

(72) Inventor: Edgar D. Young, Cashiers, NC (US)

(21) Appl. No.: 13/625,068

(22) Filed: Sep. 24, 2012

Related U.S. Application Data
(63) Continuation of application No. 12/214,728, filed on Jun. 20, 2008, now abandoned.
Application No. 12/214,728 is a continuation-in-part of application No. 11/827,814, filed on Jul. 12, 2007, now abandoned.

(51) Int. Cl. C01B 31/02

(52) U.S. Cl. CPC C01B 31/02
USPC 423/445 R

(57) ABSTRACT

The present invention relates generally to reduction of atmospheric carbon dioxide and to production of carbon therefrom for further use as, for example, fuel. More specifically, a process of dissolving atmospheric carbon dioxide into a suitable, preferably alkali metal salt flux for electrolysis thereof into carbon and oxygen is also provided.

### TECHNICAL FIELD

This application is a continuation of Ser. No. 12/214,728, filed Jun. 20, 2008, which is a continuation-in-part application of Ser. No. 11/827,814, filed on Jul. 12, 2007, now abandoned.

The present invention relates generally to fuel production, and more specifically, to carbonaceous fuel production by means of utilization of atmospheric carbon dioxide and water by “artificial photosynthesis”, as defined herein, and methods of operation thereof.

### BACKGROUND OF THE INVENTION

The current state of affairs regarding carbon dioxide and its close relationship to global warming has reached an all-time high. Many responsible sources contend that the condition of the earth's atmosphere is such that, in order to avoid the predicted dire consequences of global warming affects, removal of a portion of the existing, and increased, carbon dioxide (CO₂) from the atmosphere (in a preferred amount approximating one billion tons annually for about a decade) is needed.

The methods of the present invention meet these drastic requirements and also further provide a substantial environmental benefit in which the inventive processes hereof would require no additional energy from present earth-based fuel sources. Furthermore, the present processes produce useful and essential fuels that can be further beneficially utilized. These substantial advantages promise to usher in an energy and environmental management era of efficient and accurate climate control engineering. These results could be accomplished using known but presently unused control theories, in combination with reasonable open-loop models for short-term and extended climatic change. Moreover, and despite the long-felt need in the art for the salutary benefits provided by the several embodiments of the present invention as disclosed and claimed herein, those skilled in the art have not formulated, discovered, or utilized these most propitious solutions.

Furthermore, the product fuels produced by means of the methods of the present invention can be stored compactly and efficiently at the site of their production, thus resulting in only minimal environmental impact and eliminating the necessity to transport hazardous materials. As a matter of yet further efficiency, the required energy for use in the methods of the present invention may be harvested from solar-collecting or by wind-powered or geothermal means within the vicinity of local processing plants.

The economics of preferred embodiments of the inventive processes hereof are such that the cost of supplying energy for customer use—including electric auto transportation plus climate control storage—could allow for commonly realized profit margins, while maintaining costs at the levels traditionally charged to a customer. Furthermore, when climate levels have become stabilized according to the methods of the invention hereof, profit margins would rise substantially and/or customer costs could be substantially reduced.

A chemical process known to those skilled in the art for isolating carbon by utilizing CO₂ comprises the oxidation through burning of shredded magnesium inside a split block of frozen CO₂. The carbon thus produced appears in sizeable chunks mixed together with chunks of magnesium oxide (MgO) ash. The CO₂ and MgO can be facilitatively separated by means of shaking, combined with crushing and shifting. By these means, this separation process accordingly utilizes differences in the density of the CO₂ and MgO components of the mixture.

One further method for performing combustion of magnesium in CO₂ gas has been performed by the University of North Carolina. A ribbon of magnesium is burned in a chamber of suitable and selected size, thereby producing flecks of carbon and oxide as collected upon the chamber walls. The particle size and ease of product separation are functions of the magnesium preparation, the combustion chamber size, and the temperature profile maintained within the chamber.

However, as the combustion of magnesium is extremely exothermic, it is therefore clear that substantial advantages appear when excess heat from such a reaction chamber is harnessed by means of a heat engine cycle, resulting in the supplying of electric power to augment an input electric grid. Therefore, these considerations may impose constraints upon the combustion chamber design under the corresponding embodiment hereof, as well as upon the separation process.

Yet further, the process for producing solid carbon can be reduced to a secondary sub-process for isolating CO₂ from the air, followed by a secondary combustion process utilizing the observed fact that CO₂ supports combustion of magnesium metal. Finally, a process has been provided for separating carbon produced from the magnesium oxide ash. Processes for isolating CO₂ include freezing CO₂ ice or the use of selective solvents. These various aspects of the prior art methods necessitate different combustion chamber design requirements and physical separation requirements.

In one yet further prior art method, magnesium is recovered from the magnesium oxide ash using electrolysis, as oxygen is expelled therefrom. As set forth hereinbelow, at the end of the essentially cyclic processes of the present invention, all byproducts of the process may be returned to their initial status.

Common procedures for converting MgO to Mg include converting first to magnesium chloride by use of hydrochloric acid (releasing water) and thereafter decomposing the MgCl₂ by electrolysis in a molten salt electrolyte. Chlorine (given off at the anode) is combined with hydrogen (from electrolysis of water) to recover hydrochloric acid.

Accordingly, the inventive methods now include two major preferred embodiments as preferred processes hereof—one being as described above, and a further embodiment in which carbon dioxide may be reduced directly in one step to carbon by electrolysis.

Thus, such second major embodiment of the present invention includes the desirable feature of eliminating the requirement for an intermediate metallic oxide formation reaction, which is strongly exothermic. The objectives of the present invention are achieved, therefore, with potentially greater efficiency and yet greater simplicity.

In summary, various aspects of the problem of atmospheric CO₂ management have been addressed in previous inventions. However, none have provided the free selection of carbonaceous fuels to be produced efficiently and in a substantial capacity. Accordingly, the beneficial aspects of the present invention include the provision of processes for producing carbonaceous fuel from a first sub-process of isolating CO₂ from the atmosphere and a second sub-process for recovering magnesium.

### BRIEF SUMMARY OF THE INVENTION

The present invention relates generally to reduction of atmospheric carbon dioxide and to fuel production, and more specifically, to carbonaceous fuel production by means of utilization of atmospheric CO₂ and H₂O by “artificial photosynthesis”, as defined herein, and methods of operation thereof.

The inventive methods of the present invention may preferably comprise sub-processes for (a) producing carbon and (b) recovering magnesium. The production of carbon of step (a) may be sub-divided further into tertiary processes for isolating CO₂, for producing carbon, and for separating carbon from byproducts or ash. Yet additionally, the processes described herein may utilize the Fischer-Tropsch process as an option for producing a variety of hydrocarbon fuels.

In a second and further improved embodiment, carbon itself is utilized as a metal in the context of the present invention. Accordingly, carbon dioxide may be electrolyzed directly into carbon and oxygen; provided, however, that an electrolyte of molten metallic salts capable of dissolving carbon dioxide is used. Such molten salts that have the required relationship with carbon dioxide have now been discovered, as disclosed more particularly and as claimed herein.

The present invention may be better understood by those skilled in the art, but not unnecessarily limited, with regard to and by reference to the following detailed description of the drawings, the detailed description of preferred embodiments, the appended clams, and the accompanying drawings.

### BRIEF DESCRIPTION OF THE DRAWINGS

Accordingly, the present invention may be better understood by those skilled in the art through consideration of, and with reference to, the following Figures, viewed in conjunction with the Detailed Description of the Preferred Embodiment referring thereto, in which like reference numbers throughout the various Figures designate like structure and in which:

FIG. 1 shows a first major embodiment of the present invention, in which a process for producing carbon and for recovering magnesium is broken-down into sub-processes;

FIG. 2 shows the first major embodiment of the present invention, in which the process for carbon production is broken-down into secondary processes for isolating carbon dioxide, producing carbon, and separating carbon from byproducts or ash; and

FIG. 3 shows the first major embodiment of the present invention, further including an extension of the process that utilizes the Fischer-Tropsch process as an option for producing a variety of hydrocarbon fuels;

FIG. 4 shows a variation of the first embodiment of the present invention, in which inventive modifications to the prior art Solid Oxide Membrane (or “SOM”) process are adapted to combine the oxidation of magnesium and reduction of carbon dioxide, together with the recovery of the metal and the carbon, into a single continuously acting process; and

FIG. 5 shows a second major embodiment of the present invention, in which a further application of the SOM-type process has been adapted to the principles herein to provide the direct reduction of carbon dioxide to carbon.

It is to be noted that the figures presented herein are intended solely for the purpose of illustration and that they are, therefore, neither desired to limit nor intended to limit the present invention to any or all of the details of construction or method as shown, except insofar as they may be deemed essential to the claimed invention.

### DETAILED DESCRIPTION OF THE INVENTION

In describing preferred embodiments of the present invention illustrated in the Figures, specific terminology may be employed for the sake of clarity. The present invention, however, is not intended to be limited to the specific terminology so selected, and it is to be understood that each specific element or step thereof includes all technological equivalents that operate in a similar manner to accomplish a similar purpose.

As set forth above, FIGS, 1-4 depict a first major embodiment of the present invention, which is directed to reducing carbon from carbon dioxide (extracted from air) by oxidizing metal (such as magnesium) in an atmosphere of carbon dioxide, recovering the carbon, and then reducing the resulting metal oxide back to elemental metal.

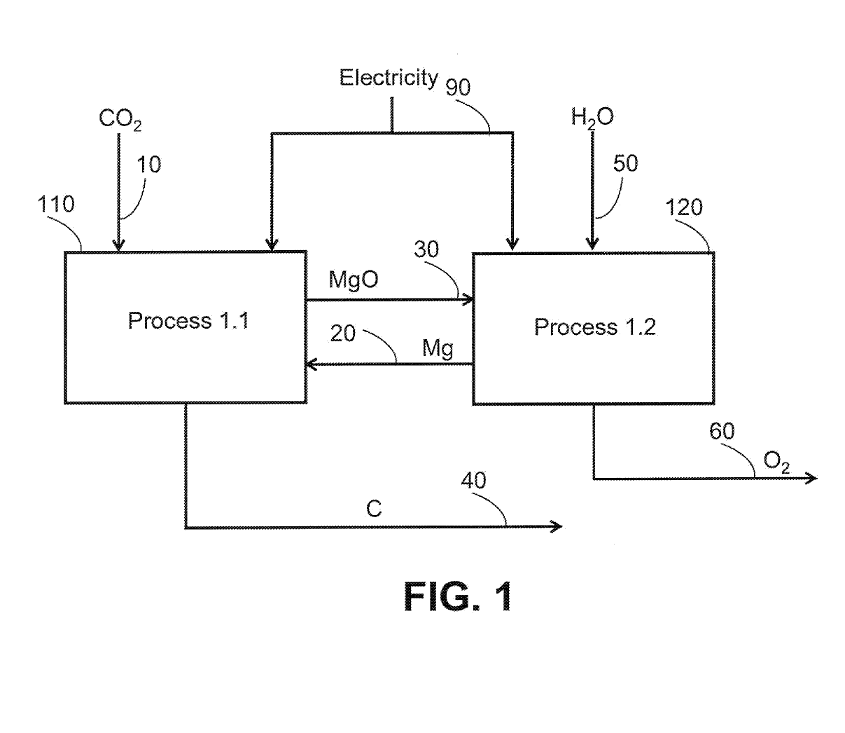

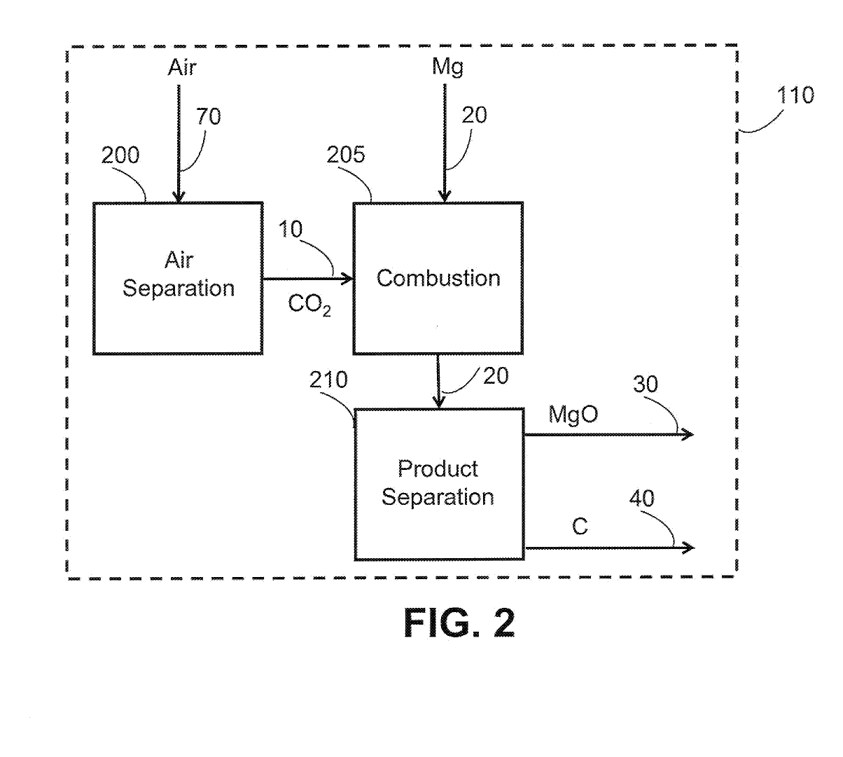

FIG. 1-5 depict a second major form of embodiment of the present invention, directed to the electrolysis of carbon dioxide directly into carbon and oxygen, which employs an electrolyte of molten metallic salts that dissolve carbon dioxide.

As chosen for purposes of illustration, FIG. 1 shows a breakdown of a main process into sub-processes for producing carbon and for recovering magnesium using Process 1.1 (110) to produce plant-related fuel (carbon) and Process 1.2 to produce fuel cell fuel (magnesium). In Process 1.1, the input comprises CO₂ (represented by line 10) and magnesium or other similar metal (line 20), and the output therefrom constitutes metallic oxide (line 30) and plant-related fuel (line 40) in the form of carbon. The means used therein preferably comprise electricity (line 90), in the form of solar energy, wind power, or geothermal means.

Process 1.2 (120) of the inventive methods herein, as illustrated schematically in FIG. 1, utilizes in preferred embodiments water (H₂O) (line 50) and spent fuel cell fuel (in the preferred form of magnesium oxide) (line 30) as inputs and produces oxygen (line 60) and fuel cell fuel (in the preferred form of elemental magnesium) (line 20) as outputs. Again, energy means (line 90)—preferably comprising electricity, solar energy, wind power, or geothermal means—are used.

Illustrated schematically in FIG, 2 is a more detailed breakdown of process 1.1 (110) of FIG. 1, in which the carbon production process is explained as secondary processes for isolating CO₂ (step 200), producing carbon (step 205), and separating carbon from byproducts or ash (step 210). Process 1.1 (110) includes the sub-steps of:

1. (step 200) Separating CO (10) from air (70), in which air (70) is an input and carbon dioxide (10) is an output;

2. (step 205) Combustion of magnesium (20) in carbon dioxide (10), utilizing magnesium (20) from the recovery process of Process 1.2 (120), described in FIGS. 1; and

3. (step 210) Separating the desired product (40) from the ash (30), which results in carbon (40) and magnesium oxide (30) as outputs.

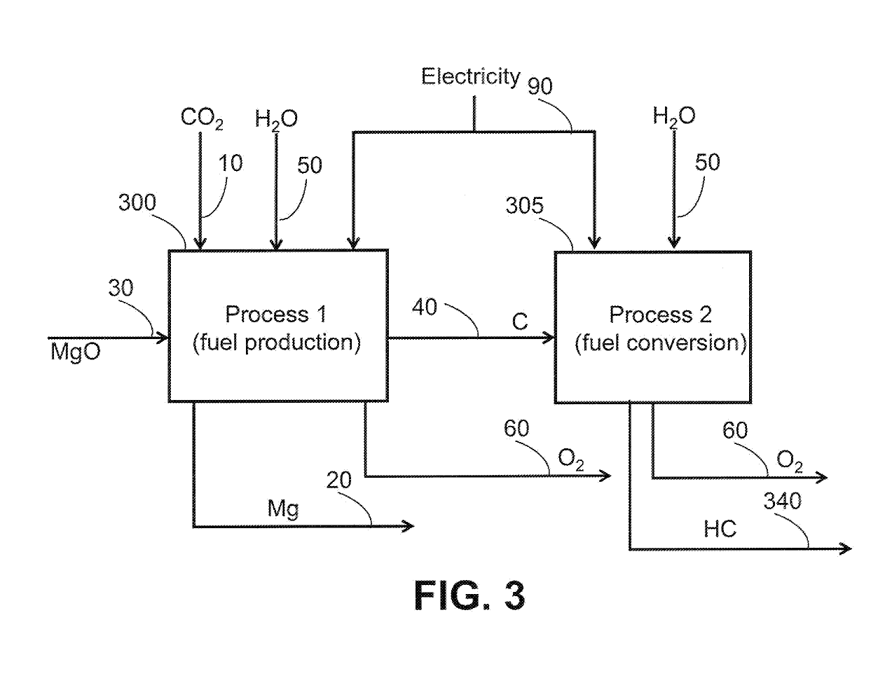

FIG. 3 schematically illustrates an extension of the main process to the basic formation of hydrocarbon fuels (340). A first subprocess (300) has an input of water (50) and atmospheric carbon dioxide (10) together with the fuel cell fuel (30), in the preferred form of magnesium oxide. The output of sub-process (300) is non-hydrogen fuel (330) for the fuel cell (in the preferred form of magnesium) and plant-related fuel (40) (in the form of carbon). The energy used therein preferably comprises electricity (90), in the form of solar energy, wind power, or geothermal means. In the second sub-process (305) of FIG. 3, the fuel conversion to the hydrocarbon fuel (340) of choice is accomplished by means of the Fischer-Tropsch Process, in which the input is water (50) and plant-related fuel (40) (in the form of carbon), and the energy used therein preferably comprises electricity 90, in the form of solar energy, wind power, or geothermal means.

In greater detail, embodiments of the present invention may be beneficially utilized to materially reduce the above-mentioned disadvantages, deficiencies, and detriments of prior art systems. Simultaneously, the present invention addresses the long-felt need for increased fuel production—and more specifically, carbonaceous fuel production—by means of atmospheric CO₂ (10) and H₂O (50) by “artificial photosynthesis” and a method of operation thereof. Accordingly, the preferred embodiments of the present invention are directed toward methods for producing carbonaceous fuel (40) from a first sub-process (200) of isolating CO₂ (10) from air (70), a second sub-process (205) for producing carbon (40) by burning magnesium (20), and a third sub-process (210) for recovering magnesium.

Hence, preferred embodiments of the present invention utilize atmospheric carbon dioxide and water to produce a variety of carbonaceous fuels. Advantageously, the only energy required for the inventive processes hereof is electrical energy, which may be obtained by solar energy means. This process may be thus defined and described herein as “artificial photosynthesis.” The “artificial photosynthesis” processes of the present invention can be operated to produce substantially no byproducts. In alternative preferred embodiments, the processes of artificial photosynthesis can optionally be operated to provide additional metallic-type fuels, which accordingly may be considered to be optimal for fuel cell applications.

In somewhat greater detail, preferred embodiments of the inventive processes herein comprise a first sub-process (110) for producing carbonaceous fuel (carbon) (40) from atmospheric CO₂ (10) and/or from a metallic fuel cell system utilizing magnesium (20), and a second process for recovering magnesium from magnesium oxide produced as a byproduct or ash from the first sub-process, with the use of water (50) as a catalyst and oxygen (60) as a byproduct—as in natural photosynthesis, but however utilizing man-directed means.

The second sub-process is essentially for the purpose of recovering magnesium. However, in further preferred embodiments of the methods of the present invention, metals other than magnesium that will readily and rapidly oxidize may be utilized in these aspects of the present methods. These metal recovery processes can in certain preferred embodiments be electrolytic, which in essence would require electrical energy. Among the most efficient mechanisms for providing this electrical energy is solar power.

Conceptually, if magnesium (20) were considered to be “fuel” for a fuel cell, magnesium oxide (30) would thus be defined as a byproduct or an “ash” within a spent fuel cell. Excess products, such as oxide ashes, can be reprocessed in the second sub-process to recover magnesium as “fuel” for the yet further use with in the fuel cell.

Yet further, utilizing the carbon fuel (40) from the second sub-process produces a variety of hydrocarbon fuels (340). These are produced by feeding carbon (40) into a catalytic process to synthesize hydrocarbons and their oxygen derivatives by the controlled reaction of hydrogen and carbon monoxide.

Again, the conventional process for converting MgO to magnesium is to first convert MgO to MgCl₂, using HCl. An alternative embodiment described herein may utilize a magnesium/nickel chromium battery (in which the magnesium cathode is replaced with magnesium oxide). A reverse charge voltage applied to this modified battery transports chloride ions to the cathode and produces nascent chlorine. Hydrogen from electrolysis of water may be introduced at the electrode to react with the chlorine, which thereafter reacts with magnesium oxide to produce magnesium chloride and thereby recover water. When the voltage is reversed again, magnesium is recovered at the cathode and the chlorine returns to storage at the anode. A benefit of this process is that transport of the chlorine gas is not necessary.

Thus, and in summary, but without limitation, in the first major embodiment of the present invention, carbon is reduced from carbon dioxide (extracted from air) by first reducing carbon dioxide to carbon by oxidizing metal (such as magnesium) in an atmosphere of carbon dioxide, collecting the carbon, and then reducing the resulting metal oxide back to elemental metal using variants of the standard recovery process.

More recently, it has been discovered that metals such as magnesium can be recovered by a simpler, more direct solid oxide membrane (SOM) process, an example of which is set forth by Krishnan, Lu, and Pal, in a paper entitled “Solid Oxide Membrane Process for Magnesium Production Directly from Magnesium Oxide,” which was published in Metallurgical and Materials Transactions, Volume 36B August 2005, pages 463-473.

An SOM process may be substituted for the more conventional metal recovery process, thereby eliminating the requirement to use water as a catalyst.

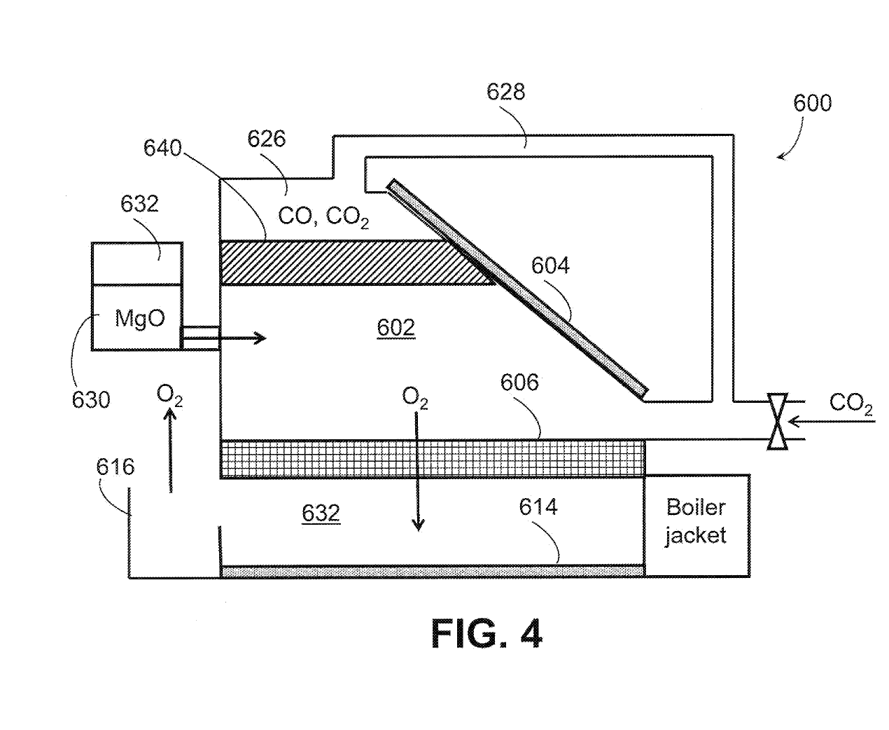

As shown in FIG. 4, an SOM process may further be applied in order to combine the reduction of carbon dioxide, oxidation of the active metal, and recovery of the active metal into a single and continuously acting process as an exemplary process of preferred embodiments of the present invention.

A pressurizable chamber (600), which can sustain pressures greater than one atmosphere, is provided. Thereafter and similar to other preferred embodiments, carbon dioxide together with the carbon monoxide produced by the process thereof are collected and maintained in a collection chamber (626) for use in the process. A renewable source of magnesium oxide is further provided by a reservoir (632), and such magnesium oxide (630) is charged into a molten flux (602), preferably comprising a molten alkalized salt, which is contained within the reaction chamber (600),

As with other embodiments, a cathode (604) is contacted with the flux (602). A non-consumable anode (614)—one example of which is set forth in U.S. Pat. No. 4,956,068—is provided and placed in communication with the flux (602). A suitable membrane (606) (an example of which is referenced, supra) is also disposed in communication with the flux (602), and a conducting fluid (632) (such as a magnesium oxide solution) is further operatively utilized to connect the membrane (606) and the anode (614),

Accordingly, the application of electric energy thereto reduces the MgO to magnesium while oxygen is vented via an outlet (616) at the anode (614). Simultaneously, the carbon oxide(s) adjacent to the cathode (604) react with the magnesium to form MgO, carbon monoxide, and free carbon, all the while maintaining gas pressure within the chamber. The carbon monoxide is continuously recycled via a recycle loop (628). The carbon may be collected periodically from a carbon layer (640).

The molten alkali salt flux (602) of such an embodiment may be selected from the group consisting of MgF and CaF, and the molten alkali salt is maintained at a temperature in the vicinity of 900° C.

Likewise, it has been discovered according to the inventive aspects herein that an SOM process might be creatively adaptable for direct reduction of carbon dioxide to carbon, provided that a suitable flux could be found. The flux would be required to dissolve carbon dioxide within a temperature range favorable for the membrane utilized,

After conducting a considerable search for such a solvent flux, suitable examples have been discovered. For example, see, the paper by Elzo Sada, Shigio Katoh, et al, in Al. Journal of Chemical & Engineering Data, Volume 26, pages 279-281 (1981).

The SOM process as applied to the electrolytic reduction of carbon dioxide provides a much simpler, if not the simplest, process for obtaining carbon from carbon dioxide, inasmuch as the reduction of carbon dioxide to carbon leaves no intermediate metallic oxide ash to be reduced in turn.

Also, the direct reduction of carbon dioxide is more efficient because there is no intermediate exothermic process. Thus, no partial energy recovery by thermal engines is needed, and separation of ash from product carbon is unnecessary.

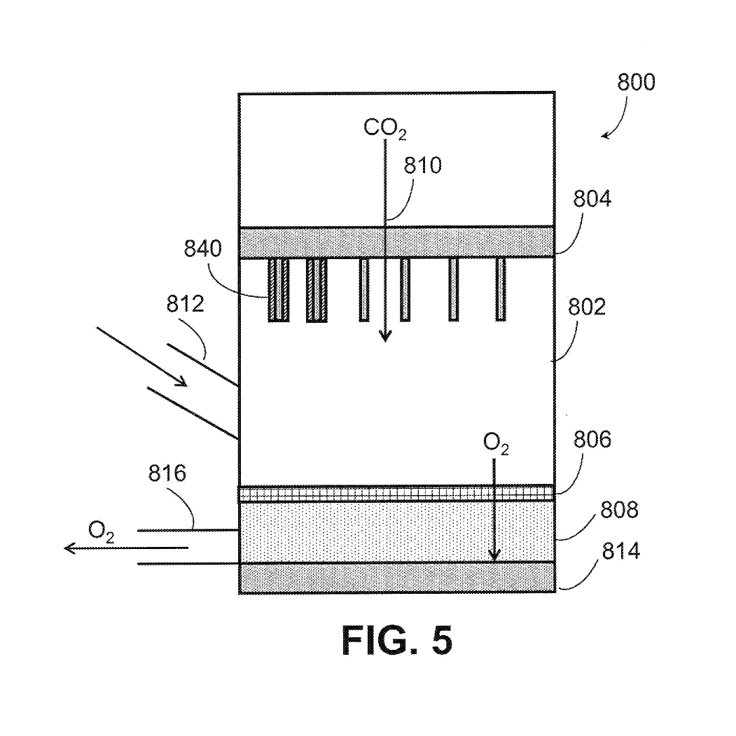

This provides motivation for the second preferred embodiment of the present invention, an example of which is illustrated in FIG. 5.

Carbon dioxide is separated from the atmosphere and thereafter charged as CO₂ stream 810 into a reaction chamber 800, which is pressurized to a pressure of from greater than 1 atmosphere to 10 atmospheres. A flux (802) is provided within the reaction chamber (800), the flux (802) comprising at least one molten alkali salt in which the carbon dioxide (810) is soluble. By way of example, the molten flux (802) may comprise potassium chloride, sodium chloride, or combinations thereof. Thereafter, the carbon dioxide (810) is dissolved in the flux (802). The halide salts in the reaction chamber (800) may be replenished via an inlet (812) into the section of the reaction chamber (800) in which the flux (802) is housed.

A cathode (804) is immersed in the flux (802), and a non-consumable anode (814) is placed in communication with the flux (802). A membrane (806) is disposed in contact with the flux (802) for transporting oxygen ions to the anode (814). In one embodiment, the membrane (806) comprises zirconium oxide. The zirconium oxide may be substantially pure. The membrane (806) may be reinforced with ytterbium. A conducting fluid (808), preferably comprising a molten metal, such as molten copper, is provided for operatively connecting the membrane (806) and the anode (814).

Electrical energy is applied to the reaction chamber (800) in order to reduce the carbon dioxide (810) into carbon and oxygen, and thereafter the carbon (840) produced thereby may be collected from the cathode (804). In addition, the oxygen resulting from the dissociation of the carbon dioxide may be collected at the anode (814) or, alternately, vented from the reaction chamber via an outlet (816). The electrical energy provided to the reactor (800) is preferably from a renewable source, such as solar energy, wind energy, or geothermal energy.

Having thus described exemplary embodiments of the present invention, it should be noted by those skilled in the art, that the within disclosures are exemplary only and that various other alternatives, adaptations, and modifications may be made within the scope and spirit of the present invention. Accordingly, the present invention is not limited to the specific embodiments as illustrated herein, but is only limited by the following claims.

What is claimed is, at least:

1. A method for producing carbon from atmospheric carbon dioxide, the method comprising:
providing a reaction chamber housing a molten flux comprising at least one alkali salt into which molten flux carbon dioxide is dissolvable;
charging carbon dioxide into a reaction chamber, causing carbon dioxide to be dissolved into the molten flux;
providing a cathode and immersing the cathode into the molten flux;
providing a non-consumable anode in communication with the molten flux;
applying electrical energy to the reaction chamber to reduce the carbon dioxide into carbon and oxygen; and
collecting the carbon produced thereby.

2. The method of claim 1, further comprising separating carbon dioxide from the atmosphere.

3. The method of claim 1, wherein the molten flux comprises at least one of potassium chloride, sodium chloride, and mixtures thereof.

4. The method of claim 1, further comprising collecting oxygen at the anode.

5. The method of claim 1, wherein the reaction chamber is pressurized to a pressure of from greater than 1 atmosphere to 10 atmospheres.

6. The method of claim 1, wherein the electrical energy applied to the reaction chamber is at least one of solar energy, wind energy, and geothermal energy.
